(19) United States
(12) Patent Application Publication
(10) Pub. No.: US 2003/0142616 A1
(43) Pub. Date: Jul. 31, 2003

(54) Optical pickup actuator including a movable portion having high stiffness

(75) Inventor: Ken?apos; ichi Hori, Kawasaki-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Mitsumi Electric Co. Ltd., Tokyo (JP)

(21) Appl. No.: 10/351,940

(22) Filed: Jan. 27, 2003

(30) Foreign Application Priority Data
Jan. 28, 2002 (JP) 18289/2002

(51) Int. Cl. G11B 21/16; G11B 17/00; G11B 7/00; G02B 7/02

(52) U.S. Cl. 369/244; 369/44.15; 359/811

(57) ABSTRACT

In an optical pickup actuator comprising a movable portion (10) including a lens holder (12) for holding an object lens (11) and a damper base (22) for supporting the movable portion through a plurality of suspension wires (34) extending from both sides thereof to allow the movable portion to shift up and down and right and left, the movable portion (10) is made of a liquid crystal polymer (40) which is material having a nature where a surface layer (41) thereof is harder than the inside (42) thereof on injection molding. The movable portion has a surface shape (a wavelike surface shape) where a surface area thereof is larger than that of a flat surface.

This application claims priority to prior application JP 2002-18289, the disclosure of which is incorporated herein by reference.

### BACKGROUND OF THE INVENTION

This invention relates to an optical pickup for use in an optical disc drive for recording/reproducing data to/from an optical recording medium such as an optical disc and, in particular, to an optical pickup actuator for movably supporting an object lens up and down and right and left (in focusing and tracking directions).

In the manner known in the art, an electric equipment such as a personal computer is connected to various peripheral units one of which comprises a memory device or a recording medium. In addition, there is various types of memory devices (recording media). In other words, the memory devices (recording media) are classified into removable media and non-removable media. One of the removable media comprises an optical disc. A wide variety of optical discs have been known. For example, an audio CD (CD-DA: compact disc digital audio), a CD-ROM (compact disc-read only memory), a CD-R (compact disc recordable), a CD-RW (compact disc rewritable), a DVD-ROM (digital versatile disc read only memory), a DVD-R (digital versatile disc recordable), a DVD-RAM (digital versatile disc random access memory), or a DVD-RW (digital versatile rewritable) has been known as the optical disc.

Now, in order to write information (data) in such as an optical disc and to read the information (data) from the optical disc, a recording/reproducing optical pickup requires for irradiating a laser beam on the optical disc.

In general, the optical pickup of the type described comprises a laser optical source for emitting the laser beam and an optical system for guiding the emitted laser beam to the optical disc. The optical system includes, for example, a diffraction grating, a beam splitter, a collimating lens, and an object lens.

It is possible for the CD-R or the like to carry out not only reading operation of information but also writing operation of information. In the optical pickup for the CD-R or the like, it is necessary to change output or power of the laser beam emitted from the laser optical source either on reading operation of information or on writing operation of information. This is because writing operation of information is carried out by forming a pit in a recording layer of the optical disc by irradiating of the laser beam. Accordingly, the output (power) of the laser beam on writing operation of information is larger than that on reading of information and is, for example, ten to twenty times as large as that on reading operation of information.

Now, in such an optical pickup, recording (writing) operation and erasing operation of information is carried out by passing the laser beam emitted from the laser optical source through the optical system and by concentrating the laser beam on a signal recording layer of the optical disc (for instance, CR-R) by the object lens of the optical system. On the other hand, reproducing operation of information is carried out by passing a reflected laser beam (return laser beam) from the signal recording layer through the optical system also and by receiving the reflected laser beam by an optical detector (a photodiode) in addition to this process.

Inasmuch as the optical disc drive carries out recording/reproducing of information for the optical disc by using the laser beam emitted from the optical pickup, it is indispensable to carry out focusing control and tracking control. In order to carry out the focusing control and the tracking control, the optical pickup comprises an optical pickup actuator for shifting the above-mentioned object lens up and down and right and left (focusing and tracking directions).

The optical pickup actuator comprises a movable portion including a lens holder for holding the object lens and a damper base for shiftably supporting the movable portion up and down and right and left through a plurality of suspension wires. Accordingly, each of the plurality of suspension wires has one end fixed to the movable portion and another end fixed to the damper base.

Now, high speed operation is required in the optical pickup year by year. With this, it is necessary to the lens holder of the optical pickup actuator to have high stiffness or rigidity.

On the other hand, although the lens holder has high stiffness, it is not suitable to operate the optical pickup at a high speed if the movable portion including the lens holder has heavy weight. It is therefore to preferably select, as material of the lens holder (the movable portion), light and hard resin material. In prior art, liquid crystal polymer (LCP) is generally used as such resin material.

However, in a known optical pickup actuator, the movable portion is made by injection molding merely using the liquid crystal polymer as the resin material without devising for a shape of the movable portion. That is, the movable portion has a flat surface. It is therefore difficult for the known optical pickup actuator to raise the stiffness of the movable portion without increasing volume and weight of the movable portion.

### SUMMARY OF THE INVENTION

It is therefore an object of this invention to provide an optical pickup actuator comprising an movable portion which is capable of effectively raising stiffness thereof without increasing volume and weight thereof.

Other objects of this invention will become clear as the description proceeds.

On describing the gist of this invention, it is possible to be understood that an optical pickup actuator comprises a movable portion including a lens holder for holding an object lens and a damper base for supporting the movable portion through a plurality of suspension wires to allow the movable portion to shift up and down and right and left. The suspension wires extend from both sides of the movable portion. According to an aspect of this invention, in the above-mentioned optical pickup actuator, the movable portion is made of material which has a nature where a surface layer thereof is harder than the inside thereof on injection molding and the movable portion has a shape where a surface area thereof is larger than that of a flat surface.

On describing the gist of this invention, it is possible to be understood that a molding product is molded by using material which has a nature where a surface layer thereof is harder than the inside thereof on injection molding. According to an aspect of this invention, the afore-mentioned molding product has a shape where a surface area thereof is larger than that of a flat surface.

The material of the above-mentioned movable portion (molding product) may be, for example, liquid crystal polymer. In addition, a surface shape of the above-mentioned movable portion (molding product) may be, for example, a wavelike shape.

### BRIEF DESCRIPTION OF THE DRAWINGS

FIG. 1 is a schematic view showing inside of liquid crystal polymer used as material for a movable portion of an optical pickup actuator to which this invention is applicable;

FIG. 2 is a plan view of an optical pickup actuator according to an embodiment of this invention;

FIG. 3 is a rear elevation of the optical pickup actuator illustrated in FIG. 2;

FIG. 4 is an enlarged detail of a portion C enclosed by a circle in FIG. 2; and

FIG. 5 is an enlarged sectional view of the portion C enclosed by the circle in FIG. 2.

### DESCRIPTION OF THE PREFERRED EMBODIMENT

In a case where liquid crystal polymer as resin material for use in molding of a movable portion, the present inventor studied as regards how to finish a shape of the movable portion in order to effectively raise stiffness of the movable portion without increasing volume and weight of the movable portion. The present inventor turned his attention to structure (nature) of the liquid crystal polymer.

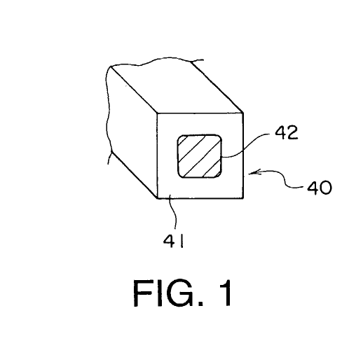

As shown in FIG. 1, the liquid crystal polymer depicted at 40 is divided two layers, namely, a hard surface layer 41 and a soft inside layer 42. The hard surface layer 41 is called a skin while the soft inside layer 42 is called a nonorientation core. The hard surface layer 41 comprises resin components whose directions are oriented in a predetermined direction. The soft inside layer 42 comprises resin components whose directions are not regular. Hardness of a part of the surface layer 41 mainly contributes to the stiffness of the liquid crystal polymer 40.

Accordingly, the present inventor arrived in an idea where it may be possible to effectively arise stiffness of the movable portion without increasing volume and weight of the movable portion if the movable portion has a shape so that a great deal of the surface layer 41 occupies in the movable portion on injection molding of the movable portion by using the liquid crystal polymer. That is, when the movable portion has a wider (larger) surface area, a ratio of the skin in the total of volume of the movable portion become higher and it results in arising the stiffness of the movable portion. A method of making the surface area of the movable portion wide (large) is, for example, to make a surface of the movable portion a wavelike shape without flat. In addition, to mold such as a product having a surface of a wavelike shape may only to work an inner wall surface of a die (mold) for use in manufacturing the movable portion into a wavelike shape.

In addition, from this point of view, it is understood that the resin material (molding material) of the movable portion is not restricted to the liquid crystal polymer and may be material having a nature where a surface layer thereof is hard and the inside thereof is soft on injection molding.

Furthermore, it is clear that this invention is not restricted to the movable portion of the optical pickup actuator and may be applicable to a general molding product.

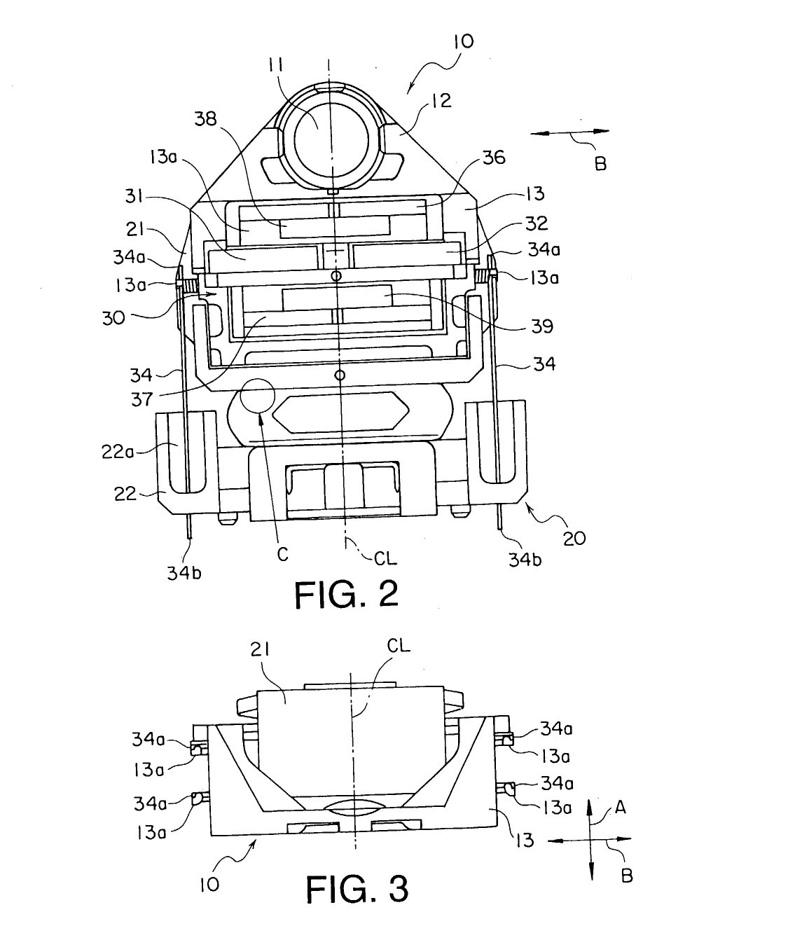

Referring to FIGS. 2 and 3, the description will proceed to an optical pickup actuator according to an embodiment of this invention. FIG. 2 is a plan view showing the optical pickup actuator. FIG. 3 is a rear elevation of the optical pickup actuator.

The illustrated optical pickup actuator comprises a movable portion 10 composing a part of an optical head (optical pickup), a fixed portion 20 for movably supporting the movable portion 10 up and down (in a focusing direction) and right and left (in a tracking direction), and a driving unit 30 mounted therein.

The movable portion 10 comprises an object lens 11, a lens holder 12 for holding the object lens 11, and a holding portion 13 for fixedly holding the lens holder 12 so as to be integrated with the lens holder. The holding portion 13 has a hole portion 13a at a center portion thereof. The driving unit 30 is mounted in the hole portion 13a. The driving unit 30 is divided into a movable part and a fixed part.

The movable part of the driving unit 30 comprises first and second tracking coils 31 and 32 and a focusing coil (not shown). The first and the second tracking coils 31 and 32 are held in the holding portion 13. Each of the first and the second tracking coils 31 and 32 is wounded in a vertical direction. The first and the second tracking coils 31 and 32 are symmetrically mounted in the holding portion 13 with respect to a central line CL. On the other hand, the focusing coil is held in the holding portion 13 in the vicinity of the first and the second tracking coils 31 and 32 in a direction of the central line CL. The focusing coil is wound in a horizontal direction. The fixed part of the driving unit 30 will later be described.

At both sides of the holding portion 13, four suspension wires 34 are disposed two by two up and down. Each of the suspension wires 34 is made of a rod or a wire member having elasticity. Each suspension wire 34 has one end 34a fixed in the holding portion at a projection 13a which is outwardly projected in the horizontal direction. Each suspension wire 34 has another end 34b fixed in a damper base (which will be later described) composing the fixed portion 20.

The fixed portion 20 comprises an actuator base 21 and the damper base depicted at 22. The actuator base 21 has a substantially rectangular frame structure made of metallic magnetic material.

Disposed in the hole portion 13a of the holding portion 13, the fixed part of the driving unit 30 comprises first and second yokes 36 and 37 and first and second permanent magnets 38 and 39. The first and the second yokes 36 and 37 are made of a part of the actuator base 21 and are stood from the actuator base. The first and the second tracking coils 31 and 32 and the focusing coil are disposed between the first and the second yokes 36 and 37. The first permanent magnet 38 is attached on a surface of the first yoke 36 that is opposite to the first and the second tracking coils 31 and 32. The second permanent magnet 39 is attached on a surface of the second yoke 37 that is opposite to the focusing coil. A combination of the first yoke 36 and the first permanent magnet 38 serves as a first fixed magnet portion while a combination of the second yoke 37 and the second permanent magnet 39 serves as a second fixed magnet portion.

That is, the driving unit 30 comprises the first and the second tracking coils 31 and 32 and the focusing coil which are held in the movable portion 10 and the first and the second yokes 36 and 37 and the first and the second permanent magnets 38 and 39 which are mounted in the fixed portion 20. By means of the driving unit 30, the movable portion 10 can move as regards the fixed portion 20 (the actuator base 21) up and down (the focusing direction)A and right and left (the tracking direction) B.

When current flows in the first and the second tracking coils 31 and 32 and the focusing coil, the driving unit 30 drives the movable portion 10 by action of magnetic flax from the first and the second fixed magnetic portions so as to relatively move as regards the fixed portion 20 (the actuator base 21) and results in regulating a focus and a tracking.

The damper base 22 has four hollow portions 22a at the four corners that allows other ends of the four suspension wires 34 to pass therethrough. Inside the hollow portions 22a, damping material for suppressing vibrations of the suspension wires 34 is injected. A rear wall of the damper base 22 has four holes (not shown) for passing through the other ends 34b of the four suspension wires 34 at the four hollow portions 22a. That is, the another end 34b of each suspension wire 34 passes through the hole of the hollow portion 22a of the damper base 22 and extends from the rear wall of the damper base 22.

In the example being illustrated, liquid crystal polymer 40 shown in FIG. 1 is used as material of the movable portion 10 (the holding portion 13). In the manner which is described above, the liquid crystal polymer 40 is particular material having nature where the surface layer 41 is hard and the inside layer 42 is soft on injection molding.

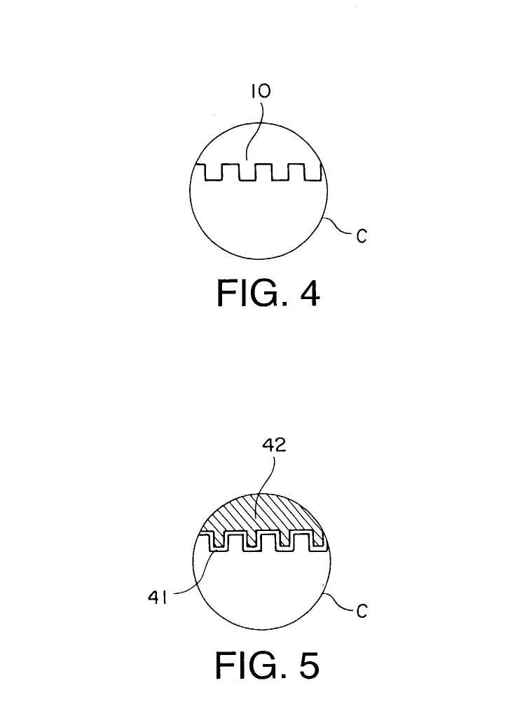

FIGS. 4 and 5 shows a portion C enclosed with a circle in FIG. 2 with the portion C enlarged. FIG. 4 is an enlarged detail of the portion C. FIG. 5 is an enlarged sectional view of the portion C.

As shown in FIG. 4, the movable portion 10 has a wavelike shape so that a surface area thereof is larger than that of a flat. In the example being illustrated, a part projected from a surface (a convex part) has a width of about 1 mm while a dent part (a concave part) has a width of about 1 mm. Accordingly, the wavelike shape has a pitch of about 2 mm. To mold such as a product having a surface of a wavelike shape may only to work an inner wall surface of a die (mold) for use in manufacturing the movable portion 10 into a wavelike shape.

As shown in FIG. 5, it is therefore possible to make a ratio of the a ratio of the surface layer (skin) 41 in the total of volume of the movable portion 10 higher in comparison with a case where the movable portion has a flat surface. As a result, it is possible to effectively arise the stiffness of the movable portion 10 without increasing volume and weight of the movable portion 10.

While this invention has thus far been described in conjunction with a preferred embodiment thereof, it will now be readily possible for those skilled in the art to put this invention into various other manners. For example, although the surface shape of the movable portion 10 is a rectangular wavelike shape in the above-mentioned embodiment, the surface shape of the movable portion 10 is not restricted to this and may be a sinusoidal wavelike shape, a shape having a lot of holes or projections, or the like. At any rate, the movable portion has a specific shape where a surface area thereof is larger than that of a flat shape. In addition, although description is exemplified in a case where the resin material of the movable portion 10 is the liquid crystal polymer (LCP) 40 in the above-mentioned embodiment, the resin material of the movable portion 10 is not restricted to this and may be particular material having a nature where a surface layer is harder than the inside on injection molding. Furthermore, although the description is made a case where this invention is applicable to the movable portion for use in the optical pickup of the optical disc drive, it will be clear for those skilled in the art that it may be possible to apply (use) this invention to a general molding product.

What is claimed is:

1. An optical pickup actuator comprises a movable portion including a lens holder for holding an object lens and a damper base for supporting said movable portion through a plurality of suspension wires to allow said movable portion to shift up and down and right and left, said suspension wires extending from both sides of said movable portion, wherein said movable portion is made of material which has a nature where a surface layer thereof is harder than the inside thereof on injection molding and said movable portion has a surface shape where a surface area thereof is larger than that of a flat surface.

2. An optical pickup actuator as claimed in claim 1, wherein the material of said movable portion is liquid crystal polymer.

3. An optical pickup actuator as claimed in claim 1, wherein said movable portion has a wavelike surface shape.

4. A molding product molded by using material which has a nature where a surface layer thereof is harder than the inside thereof on injection molding, wherein said molding product has a surface shape where a surface area thereof is larger than that of a flat surface.

5. A molding product as claimed in claim 4, wherein the material of said molding product is liquid crystal polymer.

6. A molding product as claimed in claim 4, wherein said molding product has a wavelike surface shape.
